(19) United States
(12) Patent Application Publication
(10) Pub. No.: US 2023/0342231 A1
(43) Pub. Date: Oct. 26, 2023

(54) ENHANCED PROXY FOR DISTRIBUTING AND COLLATING FOR APPLICATION PROGRAMMING INTERFACES

(71) Applicant: CenturyLink Intellectual Property LLC, Broomfield, CO (US)

(72) Inventor: Kristopher DICK, Ocean Shores, WA (US)

(73) Assignee: CenturyLink Intellectual Property LLC, Broomfield, CO (US)

(21) Appl. No.: 18/058,427

(22) Filed: Nov. 23, 2022

Related U.S. Application Data
(60) Provisional application No. 63/363,385, filed on Apr. 21, 2022.

(51) Int. Cl. G06F 9/54

(52) U.S. Cl. CPC G06F 9/546

(57) ABSTRACT

This disclosure describes systems, methods, and devices for implementing a proxy between a software's frontend and backend to distribute and collate data. A method may include receiving, by a proxy device, from software executing on a frontend of a client device, a first request for using a first backend device associated with the software; identifying, by the proxy device, based on the first request, a plurality of backend devices associated with the software; generating, by the proxy device, one or more second requests indicative of the first request; sending, by the proxy device, the one or more second requests to the plurality of backend devices; receiving, by the proxy device, from the plurality of backend devices, a plurality of responses based on the first request; generating, by the proxy device, a response including data from the plurality of responses; and sending, by the proxy device, the response to the frontend.

### CROSS-REFERENCE TO RELATED APPLICATIONS

This application is related to and claims priority under 35 U.S.C. § 119(e) from U.S. Patent Application No. 63/363,385, filed Apr. 21, 2022, titled “ENHANCED PROXY FOR DISTRIBUTING AND COLLATING FOR APPLICATION PROGRAMMING INTERFACES,” the entire content of which is incorporated herein by reference for all purposes.

### TECHNICAL FIELD

Embodiments of the present invention generally relate to systems and methods for a proxy for distributing and collating for application programming interfaces.

### BACKGROUND

Software often uses a frontend on a client device to communicate with a backend. Software on the frontend may not be capable of communicating with multiple backend instances of the software, and the backend may not be able to organize data from the multiple backend instances in a convenient manner for the frontend.

### SUMMARY

One implementation of the present disclosure may take the form of a method of implementing a proxy between a software's frontend and backend to distribute and collate data for multiple application programming interfaces (APIs). Software may be implemented on a frontend (e.g., a client device). For example, the client device may execute the software via an application, such a web browser. When the frontend of the software receives a request (e.g., a request to use multiple instances/machines available to the client device), the client device may send the request to a backend. The backend of the software may include a proxy device that receives the request and sends an indication of the request to multiple instances/machines (e.g., using respective APIs), any of which may respond to the request. The backend proxy may receive the responses of the multiple instances/machines, which may include the same or different data. The backend proxy may collate the responses of the multiple instances/machines, generating a single response to return to the frontend to represent the responses of the multiple instances/machines.

Another implementation of the present disclosure may take the form of a non-transitory computer readable medium storing instructions that, when executed by at least one processor, cause the at least one processor to perform a method of implementing a proxy between a software's frontend and backend to distribute and collate data for multiple APIs. Software may be implemented on a frontend (e.g., a client device). For example, the client device may execute the software via an application, such a web browser. When the frontend of the software receives a request (e.g., a request to use multiple instances/machines available to the client device), the client device may send the request to a backend. The backend of the software may include a proxy device that receives the request and sends an indication of the request to multiple instances/machines (e.g., using respective APIs), any of which may respond to the request. The backend proxy may receive the responses of the multiple instances/machines, which may include the same or different data. The backend proxy may collate the responses of the multiple instances/machines, generating a single response to return to the frontend to represent the responses of the multiple instances/machines.

Another implementation of the present disclosure may take the form of a system for implementing a proxy between a software's frontend and backend to distribute and collate data for multiple APIs. Software may be implemented on a frontend (e.g., a client device). For example, the client device may execute the software via an application, such a web browser. When the frontend of the software receives a request (e.g., a request to use multiple instances/machines available to the client device), the client device may send the request to a backend. The backend of the software may include a proxy device that receives the request and sends an indication of the request to multiple instances/machines (e.g., using respective APIs), any of which may respond to the request. The backend proxy may receive the responses of the multiple instances/machines, which may include the same or different data. The backend proxy may collate the responses of the multiple instances/machines, generating a single response to return to the frontend to represent the responses of the multiple instances/machines.

The software proxy may act as a middle ground between the client device and the multiple software instances/machines on the backend to which the client device may have access. In this manner, the frontend may not be configured to communicate directly with the multiple instances/machines on the backend, and not even be aware of the instances/machines on the backend. Accordingly, the frontend may send a single request to the proxy, which may identify which instances/machines are available to the client device, and may the indication of the request to the available instances/machines.

The proxy may forward the request from the client, or may generate one or more requests for the software instances/machines identified as available to the client device. The one or more requests may be formatted for the specific instances/machines, for example, using structured data such as JSON, XML, and the like. Because of the known format of the requests, the responses from the instances/machines may be recognizable to the proxy, which may use headers, attributes, and the like from one response, and drop such information from the other responses, including the additional information aggregated from the other responses. For example, when the request results in attributes having corresponding values in the responses, the proxy may collate the values from the different responses and generate a response for the front end that includes the multiple values for a given attribute. In this manner, rather than providing the frontend with multiple responses from the multiple instances/machines, the proxy may compile the results of the request—the results provided by the instances/machines—to generate a single response for the frontend.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates an exemplary software proxy environment in accordance with one embodiment.

FIG. 2 shows exemplary responses received by the proxy device of FIG. 1 and an example response generated by the proxy device of FIG. 1 in accordance with one embodiment.

FIG. 3 is a flowchart illustrating a process for implementing a proxy between a software's frontend and backend to distribute and collate data in accordance with one embodiment.

FIG. 4 is a diagram illustrating an example of a computing system that may be used in implementing embodiments of the present disclosure.

### DETAILED DESCRIPTION

Aspects of the present disclosure involve systems, methods, and the like, for implementing a proxy between a software's frontend and backend to distribute and collate data for multiple application programming interfaces (APIs).

Software often uses a frontend on a client device to communicate with a backend. However, software on the frontend may not be capable of communicating with multiple backend instances of the software, and the backend may not be able to organize data from the multiple backend instances in a convenient manner for the frontend. For example, some software runs as a single instance and cannot distribute its load across multiple instances, as the frontend of the software may not be able to communicate with multiple copies of the software on the backend. In addition, some techniques cannot compile multiple backend results of a frontend request into a single response for the frontend. While some processors may load balance, existing software techniques lack such load balancing and the ability to compile the multiple results provided by multiple backend instances into a single response for the frontend that provided the request on which the results are based.

In one or more embodiments, a proxy (e.g., software executing on a server) may act as a middle ground to process frontend software requests, distribute the frontend software requests to multiple backend instances (e.g., using respective APIs for the instances), receive responses to the request from the multiple backend instances, compile the responses into a single response, and return the single response to the frontend. The multiple backend instances may instantiate in the software's backend, remote from the proxy (e.g., not on the same server or device as the proxy).

In one or more embodiments, the software proxy may send a structured version of the request received from the frontend to the multiple backend software instances. For example, the structured request may use JSON, XML, or the like. The request may include any request to access, modify, download, upload, or the like. The software proxy may determine which instances to which the client device (e.g., frontend) has access, for example, based on geographical location of the client device, instances/APIs to which the client device is authenticated, and the like. For example, when the client device is in a physical location, the proxy may identify which instances are available for instantiation at that physical location (e.g., the instances may be spread out geographically). The client device may have access to some instances and not others based on location, access restrictions (e.g., virtual network restrictions, user restrictions, etc.). The software proxy may identify which instances may be instantiated on which machines available to the client device, and which may be capable of responding to the request received from the frontend. Once the instances/machines have been identified by the software proxy, the software proxy may send the request, or one or more indications of the request, to the instances/machines to evaluate and respond.

In one or more embodiments, the instances/machines requested by the software proxy may respond to the software proxy. Because the software proxy may receive multiple responses from the instances/machines, the software may determine which responses correspond to a particular request (e.g., differentiating between multiple requests and their respective responses), for example, using session processing. Because of the structure of the data used in the request-response exchange (e.g., JSON, XML, etc.), the software proxy may differentiate between the fields, headers, metadata, etc. and the actual data (e.g., values, payload, etc.) in the responses. To generate a single response for the frontend request based on the multiple responses from the backend instances/machines, the software proxy may extract the data from the responses, which may include multiple values per field, attribute, entry, etc., and generate a single response that indicates the multiple values per field, attribute, entry, etc. in a single response. The software proxy may return the single response to the frontend, which may not need to be aware of the multiple backend software instances/machines queried. When a response from the backend instances/machines is blank or indicates an error (e.g., a 404 error), the software proxy may discard such data so that such data is not included in the response to the frontend request.

The above descriptions are for purposes of illustration and are not meant to be limiting. Numerous other examples, configurations, processes, etc., may exist, some of which are described in greater detail below. Example embodiments will now be described with reference to the accompanying figures.

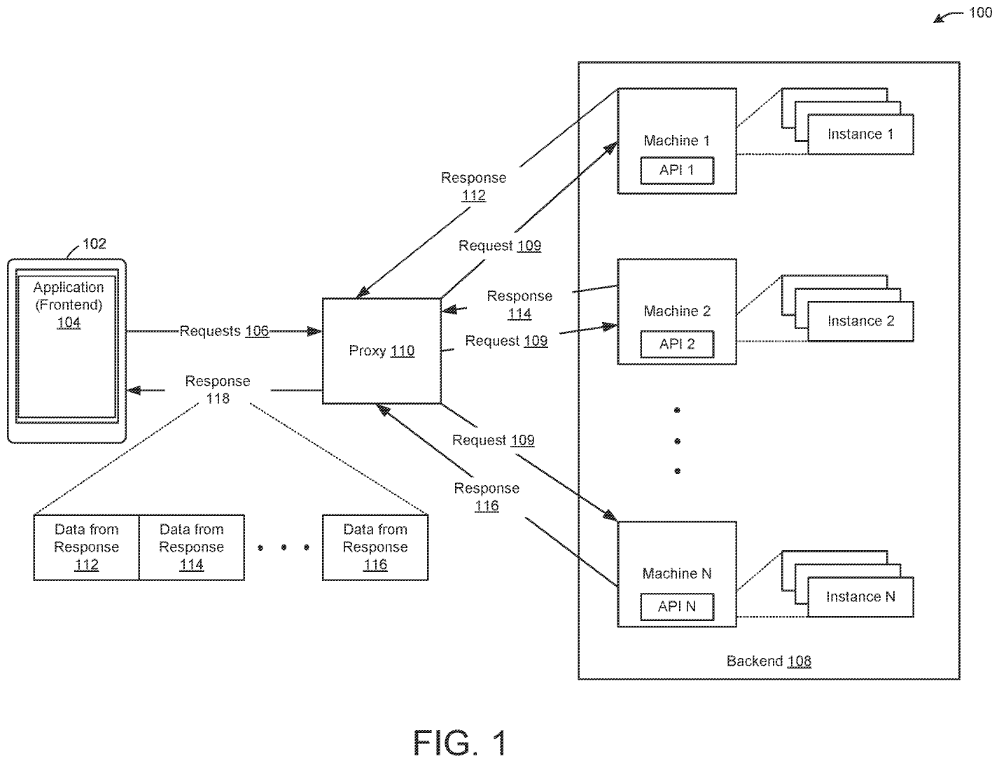

FIG. 1 illustrates an exemplary software proxy environment 100 in accordance with one embodiment.

Referring to FIG. 1, the software proxy environment 100 may include a client device 102 on which an application may execute (e.g., a frontend 104). The frontend may generate and send requests 106 associated with accessing and using one or more machines of a backend 108 of the software (e.g., one or more backend servers of the application executing on the frontend 104). Any of the requests 106 may be received by a proxy 110, and the requests 106 may not specify any particular machines to use on the backend 108 (e.g., the frontend 104 may not be aware of or configured to communicate with multiple machines on the backend 108). The proxy 110 may be aware of multiple machines of the backend 108 (e.g., machine 1, machine 2, . . . , machine N). Any of the machines may instantiate respective instances. The proxy 110 may identify which of the machines on the backend 108 is available to the frontend 104 and that may be able to respond to any of the requests 106 received from the frontend. The proxy 110 may generate and send requests 109 to the available machines (e.g., one request sent to the machines or multiple versions of a request, formatted to the machines to allow for the machines to recognize and respond to the requests 109), via respective APIs of the machines. In this manner, the proxy 110 may allow a single instance of software on the frontend 104 to communicate with multiple instances on the software's backend 108 by distributing any of the requests 106 to multiple machines on the backend 108.

Still referring to FIG. 1, the machines may generate and send responses (e.g., response 112, response 114, response 116, etc.) to the proxy 110. The proxy 110 may receive and aggregate the responses from the machines. Because the requests 109 may be sent using a particular format (e.g., XML, JSON, etc.), the responses may use the same format, allowing the proxy 110 to recognize the data/values in the responses. In this manner, a single request from the frontend 104 may result in multiple responses from the backend 108. Because some of the responses from the backend 108 may differ in terms of their content (e.g., values, payload, etc.), the proxy 110 may collate the responses to generate a single response 118 for the frontend 104 in response to one of the requests 106. The response 118 may include data from the responses received from the backend 108 machines. In this manner, the multiple results received from the backend 108 in response to a single request from the frontend 104 may be returned to the frontend 104 in one response 118 instead of in multiple different responses to a same request.

In one or more embodiments, the application executing on the frontend 104 may represent vendor software (e.g., a single instance of the software). When the application receives a user input indicating one of the requests 106 (e.g., a request to access/use one of the machines of the backend 108), the frontend 104 may generate and send one of the requests 106. The proxy 110 may represent software executing on a device (e.g., a server or some other device) that may be geographically remote from the client device 102 and geographically remote from the backend 108 machines. The backend 108 instances may represent multiple copies of the software application on the frontend 104 that execute on the backend 108 when instantiated by the machines. In this manner, the proxy 110 may distribute the processing load of the requests 106 across multiple machines on the backend 108 to execute the software on the backend. As a result of using multiple backend instances to respond to a request of the frontend, the proxy 110 may receive multiple responses to one of the requests 106 that the proxy 110 provides to the machines on the backend 108.

In one or more embodiments, the volume of responses received by the proxy 110 may be significant, such as in the hundreds or thousands. As such, without aggregating the data from the responses, the proxy 110 would otherwise have to return those many responses to the frontend 104 to process. The proxy 110 handles the processing load of the many responses by identifying the relevant data from the responses and including it in the response 118. For example, when the responses from the machines include multiple values for a same data field or attribute, the response 118 may indicate the multiple values for the same data field or attribute (e.g., instead of listing each attribute-value combination from each response of the machines on the backend 108). Any irrelevant data, such as errors indicating that the requested machines do not have or are unable to provide a response to a request, may be discarded by the proxy 110 and not included in the response 118. Instead of thousands of responses to a single request, software on the frontend 104 may receive one response 118 that may include data received from multiple instances of the software on the backend 108.

In one or more embodiments, the requests 109 may include forwarding any of the requests 106 to the machines on the backend. In other embodiments, the requests 109 may be tailored to the machines, such as by using specific data structures, including authentication information for the frontend 104 (e.g., to authenticate the frontend 104 to any machine on the backend 108, etc.). Because the proxy 110 is aware of the data structure used for the requests 109, and the associated session (e.g., to which of the requests 106 a response received from the backend 108 machines corresponds), the proxy 110 may aggregate the responses from the machines for a particular question, and extract the relevant data to include in the response 118.

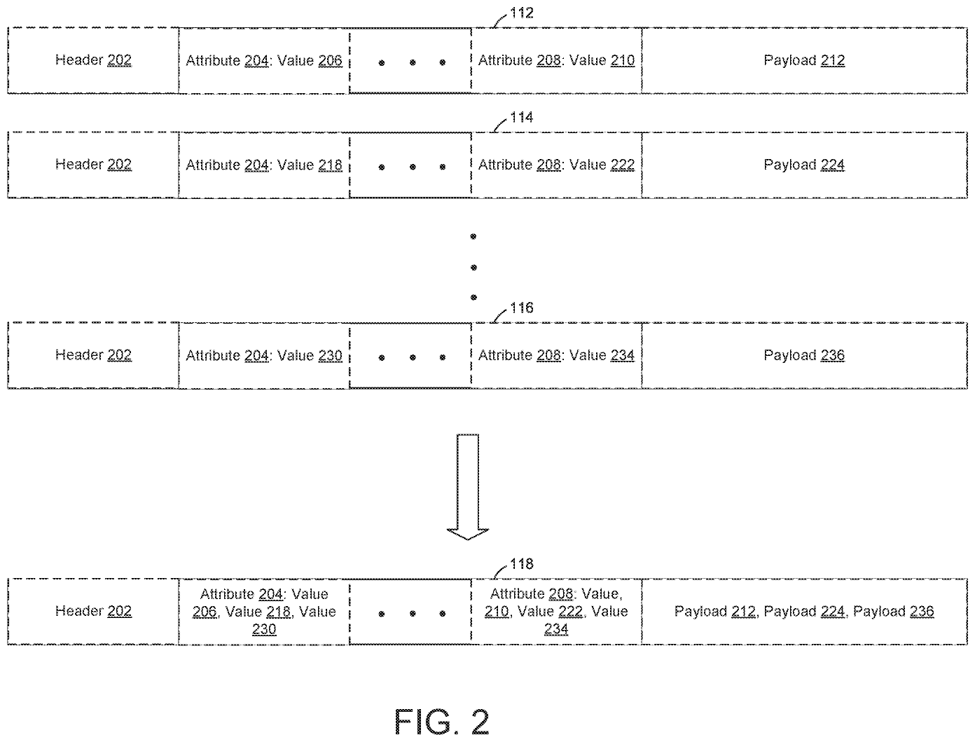

FIG. 2 shows exemplary responses (e.g., the response 112, the response 114, and the response 116 of FIG. 1) received by the proxy device 110 of FIG. 1 and an example response (e.g., the response 118 of FIG. 1) generated by the proxy device of FIG. 1 in accordance with one embodiment.

Referring to FIG. 2, the responses received by the proxy device 110 of FIG. 1 (e.g., the response 112, the response 114, and the response 116 of FIG. 1) are shown as examples of structured data. For example, the response 112, the response 114, and the response 116 optionally may include a header 202, attributes (e.g., an attribute 204, an attribute 208, etc.), values for the attributes (e.g., values 206, 210, 218, 222, 230, and 234, respectively), and payloads (e.g., payload 212, payload 224, and payload 236). Because the requests 109 of FIG. 1, sent by the proxy device to multiple backend machines for a software's backend, may use a structured format (e.g., JSON, XML, etc.), the response 112, the response 114, and the response 116 from the backend machines may be in a known format, such as is shown in FIG. 2. Because of the format known to the proxy device 110, the proxy device 110 may collect the data from the respective responses and generate the response 118 of FIG. 1 without having to repeat fields or any data, and without having to include blank fields or data indicating an error.

Still referring to FIG. 2, the response 118 generated by the proxy device 110 may include data from the response 112, the response 114, and the response 116, such as the optional header 202, any values corresponding to any particular attribute, and any payloads. For example, when multiple responses from the backend machines include values for a same attribute (or field), the response 118 may aggregate those values for the attribute (or field) as shown. In this manner, contents from the response 112, the response 114, and the response 116 may be aggregated into the response 118 as a single response returned to the frontend 104 of FIG. 1.

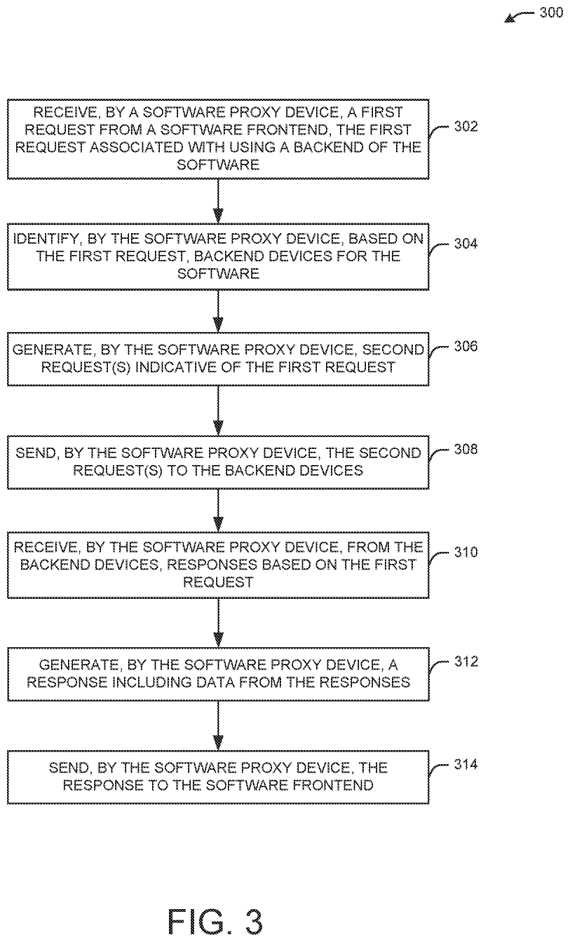

FIG. 3 is a flowchart illustrating a process 300 for implementing a proxy between a software's frontend and backend to distribute and collate data in accordance with one embodiment.

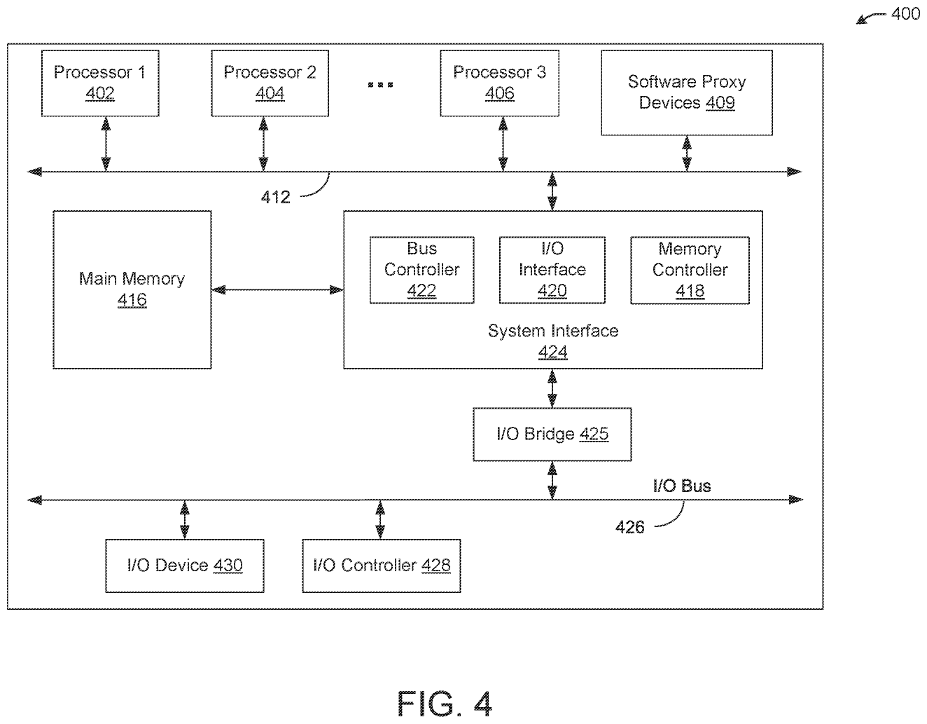

At block 302, a device (e.g., the proxy device 110 of FIG. 1, the software proxy devices 409 of FIG. 4) may receive, from a software frontend (e.g., the frontend 104 of FIG. 1), a first request associated with using a backend of the software (e.g., the backend 108 of FIG. 1). The request may indicate a need to access a machine of the backend (e.g., to instantiate one or more instances to respond to the first request). The request may indicate the data to return in response, a location of the device from which the request is received (e.g., the client device 102 of FIG. 1), user credentials (e.g., for authentication), and the like.

At block 304, the device may identify, based on the first request, backend devices of the software with which to respond to the first request. The device may identify which of the machines on the backend is available to the frontend 14 and that may be able to respond to any of the requests received from the frontend. The device may determine which instances to which the client device (e.g., frontend) has access, for example, based on geographical location of the client device, instances/APIs to which the client device is authenticated, and the like. For example, when the client device is in a physical location, the device may identify which instances are available for instantiation at that physical location (e.g., the instances may be spread out geographically). The client device may have access to some instances and not others based on location, access restrictions (e.g., virtual network restrictions, user restrictions, etc.). The device may identify which instances may be instantiated on which machines available to the client device, and which may be capable of responding to the request received from the frontend. Once the instances/machines have been identified by the device, the device may send the request, or one or more indications of the request, to the instances/machines to evaluate and respond.

At block 306, the device may generate one or more second requests (e.g., the requests 109 of FIG. 1). The requests 109 may include forwarding any of the requests 106 to the machines on the backend. The one or more second requests may be tailored to the machines, such as by using specific data structures, including authentication information for the frontend (e.g., to authenticate the frontend to any machine on the backend, etc.). Because the device is aware of the data structure used for the one or more second requests, and the associated session (e.g., to which of the one or more second requests, a response received from the backend machines corresponds), the device may aggregate the responses from the machines for a particular question, and extract the relevant data to include in a response to the frontend.

At block 308, the device may send the one or more second requests to the backend devices identified at block 306.

At block 310, the device may receive, from the backend devices to which the device sent the one or more second requests, responses (e.g., the response 112, the response 114, the response 116 of FIG. 1 and FIG. 2) that respond to the first request as indicated by the one or more second requests.

At block 312, the device may generate a response (e.g., the response 118 of FIG. 1 and FIG. 2) that includes data from the responses received from the backend devices at block 310. The volume of responses received at block 310 may be significant, such as in the hundreds or thousands. As such, without aggregating the data from the responses, the device would otherwise have to return those many responses to the frontend to process. The device handles the processing load of the many responses by identifying the relevant data from the responses and including it in the response for the frontend. For example, when the responses from the machines include multiple values for a same data field or attribute, the response to the frontend may indicate the multiple values for the same data field or attribute (e.g., instead of listing each attribute-value combination from each response of the machines on the backend). Any irrelevant data, such as errors indicating that the requested machines do not have or are unable to provide a response to a request, may be discarded by the device and not included in the response. Instead of thousands of responses to a single request, software on the frontend may receive one response that may include data received from multiple instances of the software on the backend.

At block 314, the device may send the response to the software frontend for evaluation.

It is understood that the above descriptions are for purposes of illustration and are not meant to be limiting.

FIG. 4 is a block diagram illustrating an example of a computing device or computer system 400 which may be used in implementing the embodiments of the components of the network disclosed above. For example, the computing system 400 of FIG. 4 may represent at least a portion of the software proxy environment 100 shown in FIG. 1, and discussed above. The computer system (system) includes one or more processors 402-406 and one or more software proxy devices 409 (e.g., representing at least a portion of the proxy device 110 of FIG. 1, capable of performing any operations described with respect to FIGS. 1-3). Processors 402-406 may include one or more internal levels of cache (not shown) and a bus controller 422 or bus interface unit to direct interaction with the processor bus 412. Processor bus 412, also known as the host bus or the front side bus, may be used to couple the processors 402-406 with the system interface 424. System interface 424 may be connected to the processor bus 412 to interface other components of the system 400 with the processor bus 412. For example, system interface 424 may include a memory controller 418 for interfacing a main memory 416 with the processor bus 412. The main memory 416 typically includes one or more memory cards and a control circuit (not shown). System interface 424 may also include an input/output (I/O) interface 420 to interface one or more I/O bridges 425 or I/O devices with the processor bus 412. One or more I/O controllers and/or I/O devices may be connected with the I/O bus 426, such as I/O controller 428 and I/O device 430, as illustrated.

I/O device 430 may also include an input device (not shown), such as an alphanumeric input device, including alphanumeric and other keys for communicating information and/or command selections to the processors 402-406. Another type of user input device includes cursor control, such as a mouse, a trackball, or cursor direction keys for communicating direction information and command selections to the processors 402-406 and for controlling cursor movement on the display device.

System 400 may include a dynamic storage device, referred to as main memory 416, or a random access memory (RAM) or other computer-readable devices coupled to the processor bus 412 for storing information and instructions to be executed by the processors 402-406. Main memory 416 also may be used for storing temporary variables or other intermediate information during execution of instructions by the processors 402-406. System 400 may include a read only memory (ROM) and/or other static storage device coupled to the processor bus 412 for storing static information and instructions for the processors 402-406. The system outlined in FIG. 4 is but one possible example of a computer system that may employ or be configured in accordance with aspects of the present disclosure.

According to one embodiment, the above techniques may be performed by computer system 400 in response to processor 404 executing one or more sequences of one or more instructions contained in main memory 416. These instructions may be read into main memory 416 from another machine-readable medium, such as a storage device. Execution of the sequences of instructions contained in main memory 416 may cause processors 402-406 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 406 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 416, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed:

1. A method for distributing frontend software requests to multiple backend instances via a proxy, the method comprising:
receiving, by a proxy device, from software executing on a frontend of a client device, a first request associated with using a first backend device associated with the software;
identifying, by the proxy device, based on the first request, a plurality of backend devices associated with the software, the plurality of backend devices comprising the first backend device;
generating, by the proxy device, one or more second requests indicative of the first request;
sending, by the proxy device, the one or more second requests to the plurality of backend devices;
receiving, by the proxy device, from the plurality of backend devices, a plurality of responses based on the first request;
generating, by the proxy device, a response comprising data from the plurality of responses; and
sending, by the proxy device, the response to the frontend.

2. The method of claim 1, further comprising:
determining, by the proxy device, a location of the client device,
wherein identifying the plurality of backend devices is based on the location of the client device.

3. The method of claim 1, wherein the one or more second requests use a same data format.

4. The method of claim 1, wherein the one or more second requests use a same data format use a first data format and a second data format different than the first data format.

5. The method of claim 1, further comprising:
identifying, by the proxy device, first data in a first response of the plurality of responses, the first data associated with a first field or attribute; and
identifying, by the proxy device, second data in a second response of the plurality of responses, the second data associated with the first field or attribute,
wherein the response comprises the first field or attribute, the first data, and the second data.

6. The method of claim 1, wherein the proxy is geographically remote from the plurality of backend devices.

7. The method of claim 1, further comprising:
identifying, by the proxy device, a first response of the plurality of responses; and
determining, by the proxy device, that the first response indicates an error,
wherein the error is absent from the response.

8. A non-transitory computer readable medium storing instructions that, when executed by at least one processor of a proxy device, cause the at least one processor to:
receive, from software executing on a frontend of a client device, a first request associated with using a first backend device associated with the software;
identify, based on the first request, a plurality of backend devices associated with the software, the plurality of backend devices comprising the first backend device;
generate one or more second requests indicative of the first request;
send the one or more second requests to the plurality of backend devices;
receive, from the plurality of backend devices, a plurality of responses based on the first request;
generate a response comprising data from the plurality of responses; and
send the response to the frontend.

9. The non-transitory computer readable medium of claim 8, wherein execution of the instructions further causes the at least one processor to:
determine a location of the client device,
wherein to identify the plurality of backend devices is based on the location of the client device.

10. The non-transitory computer readable medium of claim 8, wherein the one or more second requests use a same data format.

11. The non-transitory computer readable medium of claim 8, wherein the one or more second requests use a same data format use a first data format and a second data format different than the first data format.

12. The non-transitory computer readable medium of claim 8, wherein execution of the instructions further causes the at least one processor to:
identify first data in a first response of the plurality of responses, the first data associated with a first field or attribute; and
identify second data in a second response of the plurality of responses, the second data associated with the first field or attribute,
wherein the response comprises the first field or attribute, the first data, and the second data.

13. The non-transitory computer readable medium of claim 8, wherein the proxy is geographically remote from the plurality of backend devices.

14. The non-transitory computer readable medium of claim 8, wherein execution of the instructions further causes the at least one processor to:
identify a first response of the plurality of responses; and
determine that the first response indicates an error,
wherein the error is absent from the response.

15. A system for distributing frontend software requests to multiple backend instances via a proxy, the system comprising:
software executing on a frontend of a client device, configured to send, to a proxy device remote from the client device, a first request associated with using a first backend device associated with the software;
a proxy device configured to:
receive the first request;
identify, based on the first request, a plurality of backend devices associated with the software, the plurality of backend devices comprising the first backend device;
generate one or more second requests indicative of the first request;
send the one or more second requests to the plurality of backend devices;
receive, from the plurality of backend devices, a plurality of responses based on the first request;
generate a response comprising data from the plurality of responses; and
send the response to the frontend; and
a backend of the software, the backend comprising the plurality of backend devices, wherein the plurality of backend devices are configured to:
receive the one or more second requests;
instantiate instances based on the first request;
generate the plurality of responses using the instances; and
send the plurality of responses to the proxy device.

16. The system of claim 15, the one or more second requests use a same data format.

17. The system of claim 15, wherein the one or more second requests use a same data format.

18. The system of claim 15, wherein the one or more second requests use a same data format use a first data format and a second data format different than the first data format.

19. The system of claim 15, wherein the proxy device is further configured to:
identify first data in a first response of the plurality of responses, the first data associated with a first field or attribute; and
identify second data in a second response of the plurality of responses, the second data associated with the first field or attribute,
wherein the response comprises the first field or attribute, the first data, and the second data.

20. The system of claim 15, wherein the proxy is geographically remote from the plurality of backend devices.
